(19) United States
(12) Patent Application Publication
(10) Pub. No.: US 2026/0128201 A1
(43) Pub. Date: May 7, 2026

(54) METHOD & APPARATUS FOR An Reactionless Electromagnetic Engine

(71) Applicant: Ite Ed Chen, Captain Cook, HI (US)

(72) Inventor: Ite Ed Chen, Captain Cook, HI (US)

(21) Appl. No.: 18/934,259

(22) Filed: Nov. 1, 2024

(51) Int. Cl. H01F 7/20; B64G 1/40; H01F 7/06; H02N 11/00

(52) U.S. Cl. CPC H01F 7/202; B64G 1/417; H01F 7/064; H02N 11/006

(57) ABSTRACT

This invention is an Reactionless electromagnetic engine which produces thrust without propellant. It does so with one or more solenoid coils, one coil with a passive magnetic field applied to it and another coil which can be the same as the first coil with an active magnetic field. It generalizes reactionless thrusters where any free moving source of kinetic energy can be coupled to a magnet which is driven into another magnet of the opposite polarity fixed onto the system to transfer the thrust of the free moving component into the system as a whole, and where the component then must be returned to its original position to generate more kinetic energy to be transferred into the system in an additional cycle.

### CROSS REFERENCE TO RELATED APPLICATIONS

None.

### STATEMENT REGARDING FEDERALLY SPONSORED RESEARCH OR DEVELOPMENT

Not applicable.

### BACKGROUND

This section introduces information from the art that may be related to or provide context for some aspects of the technique described herein and/or claimed below. This information is background facilitating a better understanding of that which is disclosed herein. This is a discussion of “related” art. That such art is related in no way implies that it is also “prior” art. The related art may or may not be prior art. The discussion is to be read in this light, and not as admissions of prior art.

Reactionless Drives and electromagnetic engines have not received any significant patents as none of them can be demonstrated to work. The state of the Art includes the NASA's EM Drive. US Patent US20100244590A1 is an electromagnetic engine which uses electromagnetic to vibrate the drive. It does not work in theory. It does not appear there are any patents granted for NASA's EM drive. Some capacitive discharge drives have received a patent: US20170264181A1. However, none of these methods utilize the Abraham Lorentz Force or contain the idea of a momentum harness to generate electron recoil and harness the force. None of the patents or open literature suggest the use of a solenoid plunger to generate free movement which is then transferred to the system using magnets with opposite polarity with the same polarity facing each other.

### SUMMARY

This invention is an Reactionless electromagnetic engine which produces thrust without propellant. It does so with one or more solenoid coils, one coil with a passive magnetic field applied to it and the same coil or an additional coil with an actively pulsed magnetic field. The solenoid is coupled to a momentum harness to transfer the momentum generated in the core of the solenoid to the system. The coil or coils may be arranged in a geometric position which aligns with the axel of the coils, including in an overlapping manner, but preferably pressed against each other with a magnetic rod running through its axis. The magnetic rod is placed as the core of the coil or coils. The active coil receives an impulse of voltage which reflects off the passive magnetic field in the same coil or additional coils and likely induces an Abraham Lorentz force during the initial impulse due to the geometry of the parallel circuits which likely creates a recoil of the electrons in the system due to the emission of a net magnetic field in the opposite direction of the thrust in the direction of the active coil. A momentum conductor in the form of a solenoid plunger carries the momentum and strikes an impulse harness, which consists of a spring or an oppositely charged magnet, converting the momentum into thrust on the system. The passive magnetic field amplifies this thrust and returns the momentum conductor piston back into position for another cycle. This is history's first electromagnetic thruster which produces macroscopic amounts of thrust. It is efficient enough to compete with existing engine technology. Any system with a free moving body within a fixed system that can transfer its momentum to the system takes advantage of the basic principles of the thruster which consists of a free moving plunger within a solenoid actuated by a magnetic field and thrust into the spring or opposite polarity magnet or magnetic field.

The above paragraph presents a simplified summary of the presently disclosed subject matter in order to provide a basic understanding of some aspects thereof. The summary is not an exhaustive overview, nor is it intended to identify key or critical elements to delineate the scope of the subject matter claimed below. Its sole purpose is to present some concepts in a simplified form as a prelude to the more detailed description set forth below.

### DESCRIPTION OF DRAWING

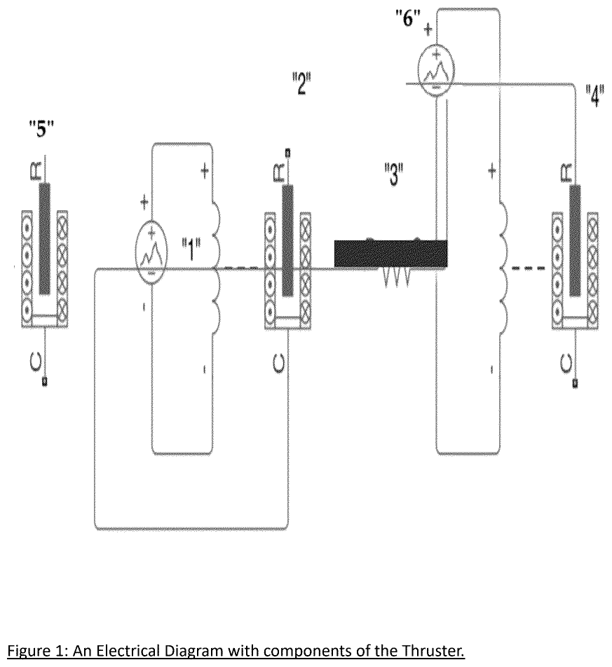

The three drawings are labeled with the same corresponding numbers. Drawing 1 is an electrical diagram and labeled FIG. 1.

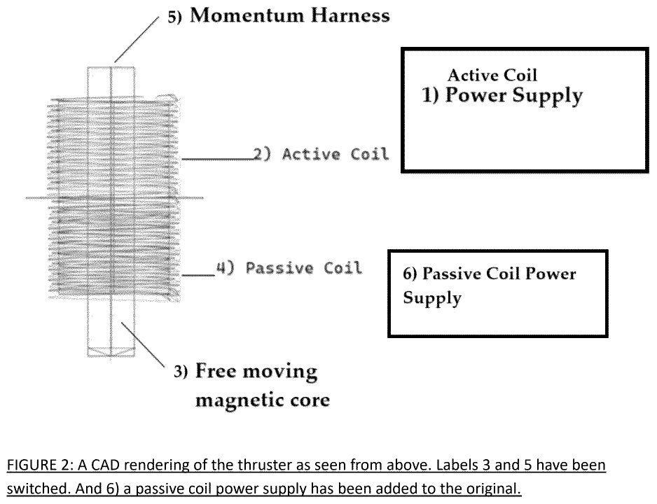

Drawing 2 is a CAD rendering of the engine as seen from the most detailed 2-d side view and labeled FIG. 2.

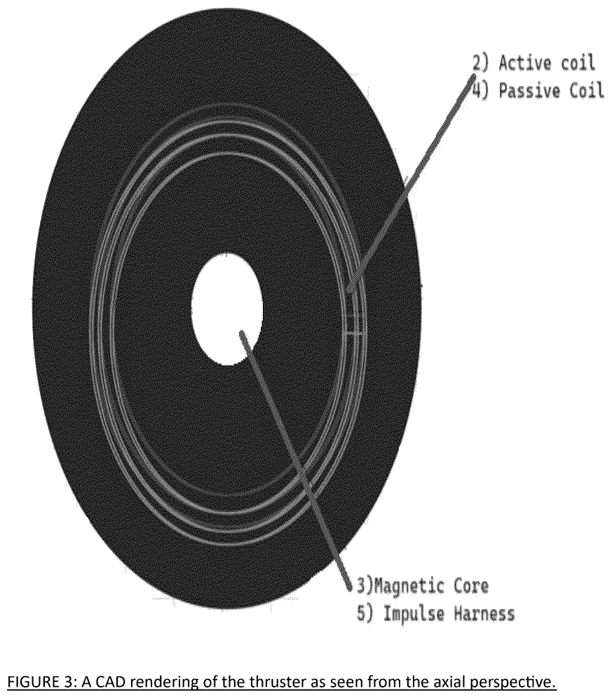

Drawing 3 is a CAD rendering of the engine as seen from its cross sectional and top view and labeled FIG. 3.

The Reactionless drive has six main components as shown in these diagrams from different perspectives and styles with all corresponding numbers the same in FIG. 1, FIG. 2 and FIG. 3. The first component “1” is a power supply which generates square pulses that power the solenoid electromagnet in “2.” This electromagnet is coupled to a second electromagnet “4” or alternatively it is a single solenoid with both the active and passive currents with a free moving magnetic conducting core which carries the momentum of the system via the magnetic conductor “3” which runs axially between the two solenoids. This core “3” can be an iron core with a magnet of the same polarity as the active and passive electromagnets attached at the active end of the iron core, or alternatively it may be a magnetic rod with the same polarity as the active and passive electromagnetic. A separate power supply may be used and is labeled “6” in to supply the power to the passive coil. The active and passive solenoids may also be combined into a signal solenoid such that “2” and “4” are a single solenoid with both an active pulse being fed into it and a passive pulse to withdraw the plunger back into position to refire. The passive electromagnet “4” is oriented in the same axial direction as “2” so that a pulse running through “2” will generate a counter magnetic pulse in “4” or a single solenoid will attain the same effect to a lesser degree. The passive electromagnetic coil “4” has a standing magnetic field either generated by the external power source “6” or from magnets and may be the same coil as the active coil when using a single solenoid. The magnetic conductor “3,” strikes “5,” an impulse harness in the form of a magnet oriented in the opposite polarity or spring coupled to the larger system which consists of a magnet oriented in opposite polarity from the polarity of the active and passive electromagnet, which converts the momentum to forward thrust on the system by repelling the moving magnetic conducting core. The impulse harness consists of a spring or an opposite polarized magnet to the polarity of the electromagnet or electromagnets “2,” “4.”

### DETAILED DESCRIPTION

The reactionless drive is an internal momentum engine which until recently has been deemed impossible under the laws of physics. The authors will extend the equation for reaction less propulsion being used in one embodiment.

This reactionless drive can be generalized and include any system with a free moving kinetic energy generator with an impulse harness in the form of a spring or a magnet or magnetic field coupled to it and a fixed magnet of magnetic field of the opposite polarity which the free moving component strikes the fixed component transferring the kinetic energy to the system as a whole. Then the free moving component is conveyed back to its original position for another cycle.

In one embodiment we can derive an additional equation, which we call “The Reactionless drive Equation” governing the system of motion,

$$Fsek = - {uq}^{⋀} 2 / {( 6 {pi}^{*} {cmr}^{⋀} 2 )}^{*} {B}^{*} dB / dt + del X E$$

The results of the paper show that significant thrusts can be generated on relatively low voltages and energy inputs. It applies this equation to explain how NASA's EM drive likely produces thrust via the “Reactionless drive Equation” using a three-circuit analysis of the Reactionless drive Force.

A reactionless drive works by generating internal momentum without the use of a propellant. According to the orthodox interpretation of the conservation of momentum, reactionless drives should be impossible. However, the authors have demonstrated a reactionless drive can be built by harnessing the Abraham-Lorentz force in a unique configuration, which captures the recoil of an electron after emitting radiation which we call the “Sektet Engine” after the Ancient Egyptian boat of the same name. There have been numerous iterations of the reactionless drive, but none except the one demonstrated by the authors have been proven to work in a level visible to the human senses.

This paper presents an extension of the engine theory that elucidates how to generate thrusts which are large enough to make a commercial impact. While the demonstration of motion produced by a reactionless drive was groundbreaking, the practical application of reactionless propulsion depends on generating thrusts which are significant compared to the mass of the thruster. Previous iterations of reactionless engines, which coupled a passive reflector coil to an active thruster coil, produced uneven forward thrusts which were difficult to standardize and measure. These coils may be adjacent loops of a single solenoid. Further development of the mathematical theory of reactionless technology elucidates ways to boost the thruster significantly. By applying a static magnetic field to the passive coil of the Reactionless drive engine, the strength of the magnetic field increases the thrust and resets the piston into position for another thrust. The Reactionless drive Equation, introduced in this paper, provides a means to increase thrust without increasing the size of the thruster. It also enables the understanding of Reactionless propulsion in general and provides the key insight to explain how NASA's impossible EM-drive produces thrust, however miniscule—as it is a highly unoptimized version of the Reactionless drive Engine as demonstrated at the Aerotech 2022 conference (Chen and Cronin 2022), which uses the Abraham-Lorentz force to produce reactionless propulsion. Rather than blindly seeking nanoscopic thrusts in systems which cannot be modeled, the Reactionless drive equation enables electromagnetic propulsion in general. This paper derives the Reactionless drive equation and then applies this to NASA's EM drive to explain how resonating vibrations in the cavity can produce forward thrust due to the Reactionless drive force as applied to a conical resonator.

In addition to the theory proposed above an additional mechanism known as the magnetic reactive radiation force may also explain the net thrust which is the primary mechanism of the momentum harness wherein the core of the electromagnet or electromagnets strike the momentum harness with a jerk dependent on the 3rd, 4th and 5th derivatives of position/time.

### The Reactionless Drive Engine:

The Reactionless drive engine consists of three basic components, at least two conducting electric lops which form magnetic fields aligned in parallel with each other and a magnetic momentum carrier to carry thrust in the axial direction between the loops. One of the loops will have a changing discontinuous impulse of magnetic flux, while the other will have a stable passive magnetic field. The two solenoids may also be combined into a single solenoid with a passive magnetic field running through it and pulses of an active magnetic field fed into it as long as the solenoid has more than one loop. FIG. 1 shows one practical iteration of a theoretical Reactionless drive engine which produced 8 Newtons of net Thrust. This system weighs less than 3 pounds (1360.78 grams). And on a smaller scale it weighs 200 grams and produces about 1 Newton of thrust.

The thrust of the system will decrease generally with the increasing temperature of the system. An ambient magnetic field in the system must also be considered as a means to boost the overall thrust of the system since equation 8 shows the thrust is directly multiplied by the existing magnetic field at the moment the engine is fired. Empirical tests have confirmed this relationship.

Where adjusting the magnetic field of the system increases the thrust.

The US Patent US20100244590A1 drive works in the same way by creating a standing electromagnetic field and then applying additional magnetic pulses into the system to create forward propulsion. It also suffers from the same drawback as the EM Drive—the lack of a magnetic momentum conductor to harness and carry the momentum limits the ability to utilize the forward momentum produced by the electrons recoiling. The Reactionless drive Engine solves this problem by developing a theory with parameters we can manipulate behind electromagnetic reactionless propulsion and optimizing the design as to capture all aspects of thrust-force. The parameters of the efficiency we must consider in a Reactionless drive engine include: The input energy of the engine, E, and the thrust output, F. The efficiency of the engine may be measured in E/F. Furthermore, the Reactionless drive Engine is enabled by the addition of a magnetic conducting momentum carrier as the core of the solenoid system. Without this, the system can only produce small amounts of vibratory thrust.

The Reactionless drive Equation:

In a previous paper, the authors proposed a unique configuration of two coils which produced thrust by channeling the Abraham Lorentz force and harnessing the moment the system “jerks.” This jerk creates a recoil force on the electron which is sufficient to move the system providing thrust to the system. The reason this occurs is that a jerking electron will emit an electromagnetic wave which carries momentum—thus the electron has to recoil to compensate for the momentum lost to the electromagnetic radiation. The Reactionless drive engine captures the momentum of the recoiling electron with a magnetic conducting momentum carrier and uses this to generate thrust.

We derived the electric version of the Reactionless drive equation from the Abraham Lorentz force in a previous publication and reproduce it in Chen and Cronin (2022):

Mathematically we can express this coupled recoil force with the Abraham-Lorentz Radiative Force Equation:

$${F}_{rad} = \frac{{μ}_{0} {q}^{2}}{6 π c} \dot{a} . \qquad ( 1 )$$

If we consider two electric loop circuits oriented along the same central axis with one active and one passive loop, at the moment a new electric field is applied to the active loop of the system, a jerk will occur due to the counter magnetic force generated in the adjacent loop. A single solenoid will also exhibit the same phenomenon such that:

$$( {V}^{*} db / dt + {B}^{*} dv / dt ) / {r}^{⋀} 2 \qquad ( 2 )$$

We also know from the force equation that:

$$F = \frac{d ( mv )}{dt} = m \frac{dv}{dt} = ma , \qquad ( 3 )$$

Set Equation 2 equal to Equation 3 and we see that the acceleration of the system is Equation 2 divided by the mass. If we differentiate this equation, we get:

$$da / dt = - 1 / ( {mr}^{⋀} 2 ) ( {v}^{*} dB / dt + {B}^{*} dv / dt ) \qquad ( 4 )$$

Inserting Equation 4 into Equation 1 gives us the equation for F-rad:

Where frad is proportional to (v*dB/dt+B*dv/dt) and the amount of charge in the system. (5)

Equation 5 gives us the equation we ended with in Chen and Cronin (2022) introducing reactionless drives. However, if we apply further analysis to equation 5 it becomes apparent that we can also express equation 5 solely in terms of the magnetic field B.

where F magnetic is proportional to B\hat{ }2/r\hat{ }2 (6)

Differentiating 6 with respect to time and isolating the derivatives gives us.

The jerk which is =−2B/mr\hat{ }2*dB/dt (7)

This tells us the Jerk of the system where the jerk and higher derivatives are the key to generating net thrust.

Inserting equation 7 into equation 1 we get:

The Sektet Force which=−uq\hat{ }2/(6pi*cmr\hat{ }2)*2B*dB/dt (8)

Equation 8 provides us with the key insight which allows us to control the thrusts produced by the engine by varying the strength of the static magnetic field, B, with which dB/dt, the changing magnetic field, will interact. We will call 8 the Reactionless drive Force. Equation 8 becomes:

$$Fsek = - u {q}^{⋀} 2 / {( 6 {pi}^{*} {cmr}^{⋀} 2 )}^{*} {B}^{*} dB / dt + del X E \qquad ( 9 )$$

When we apply Maxwell's equations:

$$del X E = dB / dt \qquad ( 10 )$$

Relating the instantaneous rate of change of the magnetic field with respect to the Curl of the Electric Field.

This equation tells us that the thrust produced by the system should be proportional to the standing magnetic field in the system multiplied by the negative of the instantaneous curl of the Electric field.

The technique disclosed herein utilizes solenoid coils a momentum conducting core and an impulse harness to obtain thrusts.

The Engine may be formed in a number of manners, but will always include a passive solenoid coil which has a static magnetic field applied to it through an external power supply or a standing magnetic field from magnets and an active solenoid coil which receives a pulse of electricity to activate the magnetic field and actuate the system, a magnetic conducting core which is free moving, and an impulse harness that the magnetic conducting core imparts its momentum into an impulse and thrust on the system.

The Active and passive coil may be arranged in any manner as long as their horizontal axis align, including in a manner where the active coil and passive coil overlap each other in the same horizontal axis wherein a magnetic conducting rod or other magnetic conductor is placed between the coil loops and an impulse harness is placed at the end of the axis of the active coil solenoid.

The voltages applied to the passive magnetic coil may range from 0.0000001 V to 1 TeraVolt or above.

The voltage pulse applied to the active magnetic coil may range from 0.0000001 V to 1 TeraVolt or above and may range in length from 1 picosecond to 1 hour.

The Teslas applied to the passive magnetic coil may range from 0.0000001 V to 1 TeraVolt or above.

The Teslas pulse applied to the active magnetic coil may range from 0.0000001 V to 1 TeraVolt or above and may range in length from 1 picosecond to 1 hour.

The active coil and passive may be conductors or semiconductors or superconductors or electric arcs nodes arranged to generate an equivalent solenoidal electromagnetic core.

Typical solenoid materials will be an effective conductor or superconductor but specific design considerations with dictate what materials are used.

The magnetic conducting momentum carrier which runs through the core of the solenoids can be a solid, such as iron, or a liquid, such as a iron slurry or a gallium alloy, or a magnetic conducting gas or plasma.

The voltage level on the active and passive coils can be used to control the resulting thrusts. The exact thrusts produced at various voltages ranging from 0.0000001 V to 10000000000000000000 V.

The compounds produced can be used in land, sea, aerospace, and space.

This method may also be applied braking applications as well as support or wave canceling earthquakes as it generates internal momentum which can counter forward momentum.

In fact, any kinetic energy source coupled to a magnet as long as its free moving and striking a momentum harness on the system, which contains the free moving kinetic energy source where the momentum harness consists of another magnet of the opposite polarity or spring will result in the momentum of the kinetic energy of the first free moving enclosed container being transferred to the system as a whole.

### EXAMPLES

A PVC pipe contains a magnetic conducting core which can move inside the pipe. Around the pipe we arrange the two solenoids, active and passive. Two power supplies are used, one with a DC current running through the passive coil made of copper to generate a smooth magnetic field within the solenoid and another power supply for the active coil made of copper, which generates large, short pulses of electricity through the active coil. A light impulse harness connected to the system consisting of a spring or an oppositely charged magnet is used to block the momentum carrier from moving too far and leaving the system and to convert the momentum into an impulse on the system to produce thrust.

A series of spark plugs are lined in a circular manner to generate a net solenoid core, and a high voltage power supply is connected to allow for electric arcing. This is our active coil. The passive coil is a superconductor solenoid. A magnetic plasma is contained in the core and allowed to circulate freely within the chamber.

A liquid slurry of magnetic carriers is used to carry the momentum and circulate in a pipe which the engine actuates repeatedly pumping the fluid through a closed loop.

A single solenoid with multiple loops with a passive voltage fed through it as well as an active pulse fed through it has a magnetic core and an oppositely polarized magnet acting as a momentum harness to repulse the core produces a net thrust forward in the direction of the magnetic impulse harness.

A magnet coupled to the pistons of an internal combustion engine wherein the engine is encased in a container and inside the container contains fixed magnets of the other polarity which the pistons strike conveying their momentum into the surrounding container propelling the system in the direction of the pistons.

A rail gun firing a magnetic core is mounted inside a closed box with a magnet of the opposite polarity as a target that is coupled to the closed box which the magnetic core being fired hits with a conveyer belt that returns the magnetic core “bullet” for an additional strike on the end target producing repeated thrusts when the magnetic bullet from the rail gun strikes the opposite polarity target.

This concludes the detailed description. The embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method for a reactionless electromagnetic engine comprising of:
One or more solenoid electromagnetic coils arranged on the same horizontal central axis using a voltage that is applied between 0.00001V to 1*10\hat{ }12 V and the amperage is between 0.00001 A to 10000000000000000 1*10\hat{ }12 Amps; one wired to a standing invariant or smoothly varying magnetic field which may be produced by the application of a voltage into the solenoid or through an external standing magnet; the single solenoid or additional solenoids are wired to a power supply which feeds it sharp pulses of electricity and where the polarity of the two magnets are the same.

2. The method of claim 1 wherein the center of the coil or coils has a free moving magnetic conductor core with a magnet of the same polarity as the electromagnets at the active end of the core which carries the momentum generated by the pulses of electricity acting on the free moving core and an impulse harness which is a spring or magnet of the opposite polarity as the electromagnets on the active end of the magnetic conductor which transmits the momentum into the system.

3. The passive coil retracts the magnetic conductor back to its original position after firing and prevents the moving core from being ejected from the solenoid.

4. The method of claim 1, wherein the coil or coils are a conductor or superconductor.

5. The method of claim 1 wherein the momentum carrier core is a magnetic conducting solid metal such as Iron, Alnico, or Neodymium.

6. The method of claim 1 wherein the power supply is controlled with a electric pulse generator controller to impart repeated pulses into the active coil.

7. The Method of claim 1 wherein the passive coil must have the same polarity as the polarity of the conducting core recharging any depolarization that occurs and the same polarity as the active electromagnet.

8. The method of claim 1 where an impulse harness is a spring or a magnet of the opposite polarity or another electromagnet which converts the momentum generated in the magnetic conductors into a thrust in the system by absorbing the impact of the magnetic conductor.

9. The method of claim 1 where a magnet of opposite polarity as the momentum conducting core and the electromagnet acts as the impulse harness and converts the forward thrust of the momentum conductor into an impulse that is imparted onto the system.

10. The method of claim 1 wherein the standing variable magnetic field is generated by an external magnet such as neodymium.

11. The method of claim 1 wherein an electric current is run through the magnetic momentum conductor to increase its magnetic constant and susceptibility.

12. A method where multiple reactionless drives are arranged on a spacecraft or satellite platform such as a cube satellite in a parallel array or serial array of repeating thrusting engines with a timer to control the firings to provide unlimited specific impulse and 6 axis-maneuverability controlled by a GNC algorithm connected to an IMU.

13. The method of claim 12 wherein the reactionless drives are mounted on a gimble.

14. A method for reactionless thrusters which generates reactionless thrust by harnessing momentum or kinetic energy wherein one magnet or magnetic field coupled to the source of the kinetic energy strikes another magnet or magnetic field of an opposite polarity wherein one magnet is coupled to a kinetic energy source such as a free moving solenoid core such as one fired from a rail gun or any other source of kinetic energy such as a bullet or a piston of an internal combustion engine while another harnesses the kinetic energy and conveys it to the system moving from the net thrust by colliding with the first magnet with an opposite polarity on the free moving kinetic energy source; And wherein the kinetic energy source is then returned to its original position by the reflection of the opposite polarity magnetic with or without an additional force such as a conveyor belt or an engine for an additional cycle of the engine.
